(19) United States
(12) Patent Application Publication
(10) Pub. No.: US 2025/0094880 A1
(43) Pub. Date: Mar. 20, 2025

(54) Fully Private Ensembles Using Knowledge Transfer

(71) Applicant: Google LLC, Mountain View, CA (US)

(72) Inventor: Preston Wooju Lee, Bellevue, WA (US)

(21) Appl. No.: 18/013,328

(22) PCT Filed: Dec. 14, 2022
(86) PCT No.: PCT/US2022/052851

§ 371 Date: Dec. 28, 2022

(51) Int. Cl. G06N 20/20

(52) U.S. Cl. CPC G06N 20/20

(57) ABSTRACT

Example embodiments of the present disclosure provide for an example method including obtaining a private dataset. The example method includes dividing the private dataset into a first data subset and a second data subset. The example method includes training a first teacher model using the first data subset and a second teacher model using the second data subset. The example method includes generating the aggregate teacher model based at least in part on the trained first teacher model and the trained second teacher model. The example method can include obtaining a modified dataset that was generated based on a private dataset and labeling the modified dataset by the aggregate teacher model. The example method can include training a publicly available student model using the labeled modified dataset.

### FIELD

The present disclosure relates generally to training machine learned models using a private aggregate teacher ensemble.

### BACKGROUND

Differential privacy of user data is of major importance especially in industries such as healthcare. Private aggregate teacher ensembles can be used to train publicly available models with private data and labeled public data.

### SUMMARY

Aspects and advantages of embodiments of the present disclosure will be set forth in part in the following description, or can be learned from the description, or can be learned through practice of the embodiments.

In one example aspect, the present disclosure provides for an example system for training machine learned models using a private aggregate teacher ensemble, including one or more processors and one or more memory device storing instructions that are executable to cause the one or more processors to perform operations. In some implementations, the one or more memory devices can include one or more transitory or non-transitory computer-readable media storing instructions that are executable to cause the one or more processors to perform operations. In the example system, the operations can include obtaining a first private dataset. In the example system, the operations can include dividing the private dataset into at least a first data subset and a second data subset. In the example system, the operations can include training a first teacher model using the first data subset. In the example system, the operations can include training a second teacher model using the second data subset. In the example system, the operations can include generating an aggregate teacher model based at least in part on the trained first teacher model and the trained second teacher model. In the example system, the operations can include obtaining a modified dataset that was generated based on a private dataset. In the example system, the operations can include labeling the modified dataset by the aggregate teacher model. In the example system, the operations can include training a publicly available student model using the labeled modified dataset.

In some embodiments of the example system, the publicly available student model is a non-differentially private machine learning algorithm.

In some embodiments of the example system, obtaining the modified dataset includes obtaining a private data subset, wherein the private data subset is at least one of a third data subset of the private dataset or wherein the private data subset is a second private dataset. In some embodiments of the example system, obtaining the modified dataset includes performing a method to modify the private data subset. In some embodiments of the example system, obtaining the modified dataset includes obtaining output comprising the modified dataset in response to performing the operation to modify the private data subset.

In some embodiments of the example system, performing the method to modify the private data subset comprises adding noise to the private data subset.

In some embodiments of the example system, obtaining the modified dataset includes performing a differentially private generation algorithm on the private dataset. In some embodiments of the example system, obtaining the modified dataset includes obtaining, from the differentially private generation algorithm, output comprising the modified dataset, wherein the modified dataset comprises an unlabeled modified dataset.

In some embodiments of the example system, the at least first and second teacher models comprise at least one of regression models, classification models, naive Bayesian models, neural networks, decision trees, random first models, or support vector machines.

In some embodiments of the example system, the publicly available student model comprises at least one of regression models, classification models, naive Bayesian models, neural networks, decision trees, random forest models, or support vector machines.

In some embodiments of the example system, wherein the first data subset and the second data subset are disjoint subsets of the private dataset.

In some embodiments of the example system, the operations include determining that there is not a publicly available training dataset. In some embodiments of the example system, the operations include in response to determining that there is not a publicly available training dataset, generating the modified dataset, labeling the modified dataset, and training the publicly available student model using the labeled modified dataset.

In some embodiments of the example system, obtaining the modified dataset includes dividing the private dataset into at least the first data subset, the second data subset, and a third data subset, wherein the first data subset, the second data subset, and the third data subset are disjoint subsets of the private dataset. In some embodiments of the example system, obtaining the modified dataset includes performing a differentially private generation algorithm on the third data subset. In some embodiments of the example system, obtaining the modified dataset includes obtaining, from the differentially private generation algorithm, output comprising the modified dataset, wherein the modified dataset comprises an unlabeled modified dataset.

In some embodiments of the example system, the private dataset contains medical records of a plurality of individuals.

In some embodiments of the example system, the private dataset contains advertisement data associated with a plurality of advertisers.

In some embodiments of the example system, the operations include obtaining a second private dataset. In some embodiments of the example system, the operations include inputting the second private dataset into the trained student model. In some embodiments of the example system, the operations include obtaining output from the trained student model indicative of a prediction associated with the second private dataset.

In an example aspect, the present disclosure provides for an example computer-implemented method. The example method includes obtaining a first private dataset. The example method includes dividing the private dataset into at least a first data subset and a second data subset. The example method includes training a first teacher model using the first data subset. The example method includes training a second teacher model using the second data subset. The example method includes generating an aggregate teacher model based at least in part on the trained first teacher model and the trained second teacher model. The example method includes obtaining a modified dataset that was generated based on a private dataset. The example method includes labeling the modified dataset by the aggregate teacher model. The example method includes training a publicly available student model using the labeled modified dataset.

In some embodiments of the example method, the publicly available student model is a non-differentially private machine learning algorithm.

In some embodiments of the example method, obtaining the modified dataset includes obtaining a private data subset, wherein the private data subset is at least one of a third data subset of the private dataset or wherein the private data subset is a second private dataset. In some embodiments of the example method, obtaining the modified dataset includes performing a method to modify the private data subset. In some embodiments of the example method, obtaining the modified dataset includes obtaining output comprising the modified dataset in response to performing the operation to modify the private data subset.

In some embodiments of the example method, performing the method to modify the private data subset comprises adding noise to the private data subset.

In some embodiments of the example method, obtaining the modified dataset includes performing a differentially private generation algorithm on the private dataset. In some embodiments of the example method, obtaining the modified dataset includes obtaining, from the differentially private generation algorithm, output comprising the modified dataset, wherein the modified dataset comprises an unlabeled modified dataset.

In some embodiments of the example method, the at least first and second teacher models comprise at least one of regression models, classification models, naive Bayesian models, neural networks, decision trees, random first models, or support vector machines.

In some embodiments of the example method, the publicly available student model comprises at least one of regression models, classification models, naive Bayesian models, neural networks, decision trees, random forest models, or support vector machines.

In some embodiments of the example method, wherein the first data subset and the second data subset are disjoint subsets of the private dataset.

In some embodiments of the example method, the method includes determining that there is not a publicly available training dataset. In some embodiments of the example method, the method includes in response to determining that there is not a publicly available training dataset, generating the modified dataset, labeling the modified dataset, and training the publicly available student model using the labeled modified dataset.

In some embodiments of the example method, obtaining the modified dataset includes dividing the private dataset into at least the first data subset, the second data subset, and a third data subset, wherein the first data subset, the second data subset, and the third data subset are disjoint subsets of the private dataset. In some embodiments of the example method, obtaining the modified dataset includes performing a differentially private generation algorithm on the third data subset. In some embodiments of the example method, obtaining the modified dataset includes obtaining, from the differentially private generation algorithm, output comprising the modified dataset, wherein the modified dataset comprises an unlabeled modified dataset.

In some embodiments of the example method, the private dataset contains medical records of a plurality of individuals.

In some embodiments of the example method, the private dataset contains advertisement data associated with a plurality of advertisers.

In some embodiments of the example method, the method includes obtaining a second private dataset. In some embodiments of the example method, the method includes inputting the second private dataset into the trained student model. In some embodiments of the example method, the method includes obtaining output from the trained student model indicative of a prediction associated with the second private dataset.

In an example aspect, the present disclosure provides for an example transitory or non-transitory computer readable medium embodied in a computer-readable storage device and storing instructions that, when executed by a processor, cause the processor to perform operations. In the example transitory or non-transitory computer readable medium, the operations include obtaining a first private dataset. In the example transitory or non-transitory computer readable medium, the operations include dividing the private dataset into at least a first data subset and a second data subset. In the example transitory or non-transitory computer readable medium, the operations include training a first teacher model using the first data subset. In the example transitory or non-transitory computer readable medium, the operations include training a second teacher model using the second data subset. In the example transitory or non-transitory computer readable medium, the operations include generating an aggregate teacher model based at least in part on the trained first teacher model and the trained second teacher model. In the example transitory or non-transitory computer readable medium, the operations include obtaining a modified dataset that was generated based on a private dataset. In the example transitory or non-transitory computer readable medium, the operations include labeling the modified dataset by the aggregate teacher model. In the example transitory or non-transitory computer readable medium, the operations include training a publicly available student model using the labeled modified dataset.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram for training machine learned models according to example embodiments of the present disclosure.

FIG. 2 depicts a block diagram for generating modified data according to example embodiments of the present disclosure.

FIG. 3 depicts an example graph depicting original data compared to modified data according to example embodiments of the present disclosure.

FIG. 4 depicts a flowchart of an example method according to example embodiments of the present disclosure.

FIG. 5 depicts a block diagram of an example system for performing fully private ensembles using knowledge transfer according to example embodiments of the present disclosure.

### DETAILED DESCRIPTION

Generally, the present disclosure is directed to systems and methods for training publicly available models using fully private ensembles using knowledge transfer. This allows for use and training of ensembles of machine learned models without access to public data. The method includes generating modified datasets from private datasets to be used in a private aggregate teacher ensemble (PATE) model without access to public data for training the public model.

Differential privacy of user data is of major importance especially in industries such as healthcare, advertising, and the like. The systems and methods of the present disclosure provide for training of publicly available machine learned models while providing for differential privacy of the original private training data sets. Modified training data can be generated based on private data sets to be labeled and used for training the publicly available student machine learned model. In more detail, sets of user data such as patient medical data, advertisement data, user input data, financial data, or communications data may be required to remain differentially private when being processed by machine learning models. However, in many scenarios, non-differentially private models are required to analyze differentially private patient data. The present disclosure seeks to address this and other problems encountered in the prior art.

PATE involves the division of a private dataset into subsets (also known as chunks) to be used to train multiple discrete private machine learned models. The output of these models can be used to generate an aggregated machine learned model (e.g., classifications/labels for various inputs). In traditional PATE methods, the output of this machine learned model can be used to label a publicly available dataset to train a public facing machine learned model. Labeling can include classifying or categorizing data. For instance, unlabeled data can include the initial private dataset used for training the parent models. Labeled data can include the modified data that has been processed by the trained parent models and labeled with a classification or categorization. The labeled modified data can be used to train the student model. Because the public facing model was trained based on labeled public data, an infinite number of estimates can be determined using the public facing model without affecting the differential privacy of the original private dataset.

Traditional implementations of PATE provide for improved differential privacy but are only helpful when public datasets exist and are available. Existing methods describe the PATE model generating completely modified data to be used to train the publicly available student model, but this requires the predictors for the ensemble to be good discriminators for whether or not a sample is real or modified data.

The current disclosure provides for implementation of the PATE model without the use of public datasets. The present disclosure allows for generating a modified dataset by performing a differentially private generation algorithm on the private dataset to generate an unlabeled modified dataset. Thus, a private dataset can be obtained and modified. The modified dataset can be used to train the publicly available student model while ensuring an acceptable level of differential privacy for the initial private dataset.

The present disclosure provides for technical solutions to technical problems of training publicly available models in a differentially private way as well as preventing overfitting of the student model to training datasets. The differential privacy allows for infinite queries of the public student model without increasing the security cost that would be associated with a public model directly trained on the private dataset. Thus, the effect of making an arbitrary single substitution in the private dataset would be small enough to prevent any inferences about single individuals associated with the private dataset.

The present disclosure provides for additional technical solutions including improving runtime and training time for the publicly available model. Because the teacher models can be trained in parallel, if the based model training time scales linearly with the number of training examples, then a parallel PATE training scheme can train n times faster, wherein n is the number of teacher models in the PATE ensemble. Training the publicly available student model can consume an amount of time proportional to the agreement of teachers. As there is more agreement between the teacher, more training samples can be shown to the student model. As described herein, a student model can be a publicly available machine-learned model that can be trained using the PATE training scheme. As described herein, a teacher model can be a private model that is part of the parallel PATE training scheme.

More details and technical benefits of the disclosure can be appreciated through the discussion of the figures. The systems and methods can include obtaining a dataset D and performing a noisy aggregation function A. The systems and methods can include splitting dataset D into chunks C₁, C₂, . . . , Cₙ. The systems and methods can include training a teacher model Tᵢ on each Ci to create ensemble E={T₁, T₂, . . . , Tₙ}. The systems and methods can include modifying (e.g., perturbing) dataset D in a differentially private way to generate D¹. Generating D¹ can incur a ε₁ privacy budget cost. The systems and methods can include gathering labels from teachers: L=A(E(D¹)). Gathering labels from teachers can incur a ε₂ privacy budget cost. The systems and methods can include training a student S on D¹ with labels L. The total privacy budget can be represented as follows: ε_{T}=ε₁+ε₂. ET can represent the total privacy budget allowed for training the publicly available student model. The total privacy budget can vary based on the type of private data in the training dataset or a user input of an acceptable privacy budget. For instance, a privacy budget of 0.1 can indicate a small level of privacy spend and a privacy budget of 1.0 can represent a high level of privacy spend. A privacy budget can be a normalized value between 0 and 1 (or 0 and 100). ε₁ can represent a privacy budget allocated to training the ensemble of teacher models. ε₂ can represent the privacy budget allocated to training the publicly available student model. The present disclosure provides for a guaranteed privacy budget cost on dataset D of ε_{T}=ε₁+ε₂. While the methods described herein can provide for the same dataset D for training the teacher models as the student model, the methods can include training the teacher models and student model on different datasets. This would result in a spend of ε₁ on the dataset for the teachers and ε₂ on the dataset used to train the student.

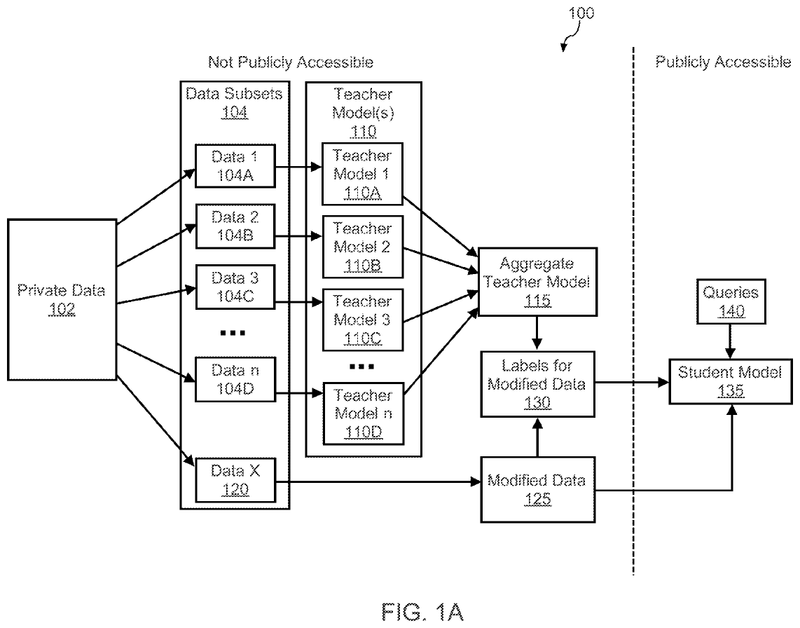

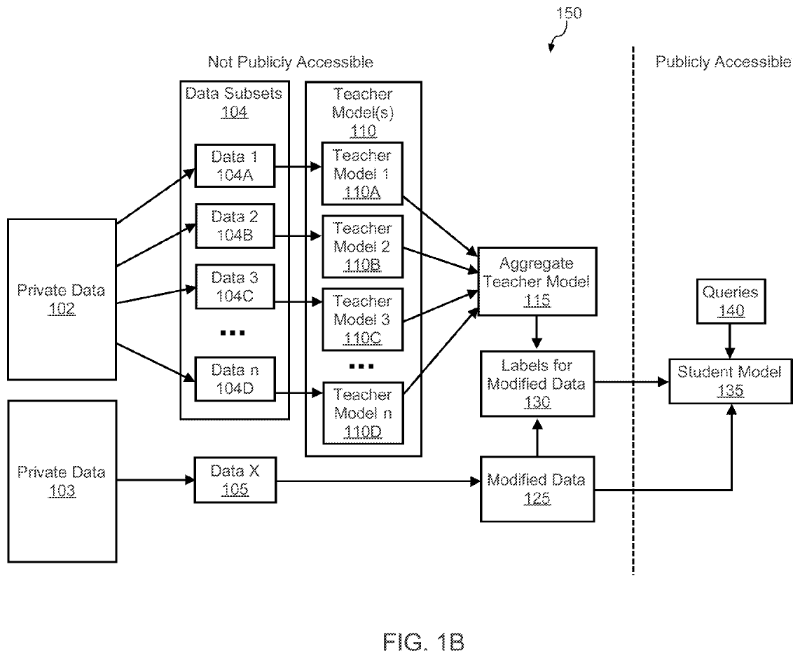

FIG. 1A depicts example data flow 100 for training a publicly accessible student model 135 through a private aggregate teacher ensemble without public data according to example embodiments of the present disclosure. The private aggregate teacher ensemble can include private data 102. Private data 102 can be divided into a plurality of data subsets 104. Data subsets 104 can include data 1 104A, data 2 104B, data 3 104C, data n 104D, and data x 120. The data subsets 104 can be disjoint data subsets (e.g., all containing distinct sets of data with no overlap). In some implementations, the data subsets can be overlapping subsets (e.g., some data subsets contain some of the same data as other data subsets). Data 1 104A through data n 104D can be associated with respective machine learned teacher models 110. For example, machine learned teacher models 110 can include teacher model 1 110A, teacher model 2, 110B, teacher model 110c, and teacher model n 110D. Each teacher model can be trained by a respective, distinct data subset. By way of example, teacher model 1 110A can be trained using data 1 104A, teacher model 2 110B can be trained using data 2 104B, teacher model 3 110C can be trained using data 3 104C, and teacher model n 110D can be trained using data n 104D.

Data flow 100 can include obtaining output from the plurality of teacher models 110. The output can be obtained by aggregate teacher model 115. By way of example, aggregate teacher model 115 can obtain output for teacher models 110 and generate a data structure comprising the distribution of the output data. In some implementations, the data structure can be a histogram. In some instances, the histogram can represent a frequency of an output result obtained from the plurality of teacher models 110.

For example, the agreement of the votes can become an empirical measure of the model sensitivity. In some instances, the model sensitivity can be upper-bounded. In some implementations, noise can be added to the predictions. (e.g., votes). The noisy predictions can create differentially private predictions with respect to the training dataset. The noisy predictions can be used on the modified data to create teacher labels.

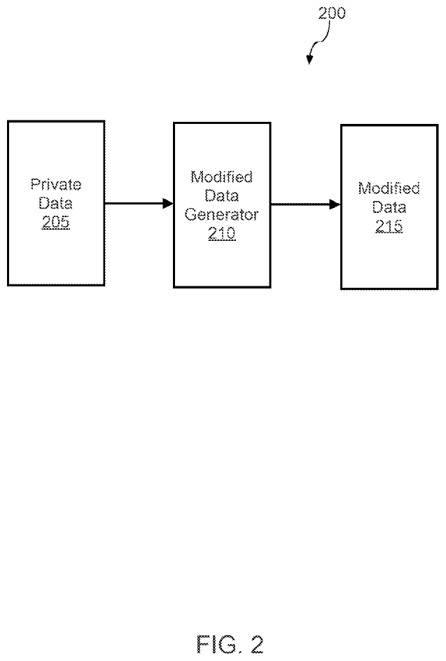

Data flow 100 can include obtaining data x 120 of private data 102. Data x 120 can be modified to generate modified data 125 (e.g., as described in FIG. 2). By way of example, data can be modified in a differentially private way to generate modified data 125.

Aggregate teacher model 115 can be used to generate labels for modified data 130. Labels for modified data 130 and modified data 125 can be used to train student model 135. Student model 135 can be a publicly available model. Queries 140 can be run on student model 135 an infinite number of times without sacrificing additional differential privacy budget spent in the initial training of the aggregate teacher model 115.

As described herein, the present disclosure provides for recovering decision boundaries of the respective teacher models at a fair resolution. Thus, so long as the teacher ensemble gives a correct label to a data point, it will be useful for the publicly available student model even if the data point is not “real” data, it can be useful for training the publicly available student model. Therefore, the modified dataset can be extremely noisy (and thus more differentially private) and still be useful for training the publicly available student model.

This provides for technical benefits. For example, unlike a model that generates completely new modified data, this data has a similarity of distribution to the original private dataset. Thus, different models are being used for generation of the modified dataset and categorizing the dataset (e.g., processing the modified dataset by the trained teacher model to generate labels for the modified data and training the student model on the labeled modified data).

FIG. 1B depicts example data flow 150 for training a publicly accessible student model 135 through a private aggregate teacher ensemble without public data according to example embodiments of the present disclosure. The private aggregate teacher ensemble can include private data 102. Private data 102 can be divided into a plurality of data subsets 104. Data subsets 104 can include data 1 104A, data 2 104B, data 3 104C, and data n 104D. The data subsets 104 can be disjoint data subsets (e.g., all containing distinct sets of data with no overlap). In some implementations, the data subsets can be overlapping subsets (e.g., some data subsets contain some of the same data as other data subsets). Data 1 104A through data n 104D can be associated with respective machine learned teacher models 110. For example, machine learned teacher models 110 can include teacher model 1 110A, teacher model 2, 110B, teacher model 110c, and teacher model n 110D. Each teacher model can be trained by a respective, distinct data subset. By way of example, teacher model 1 110A can be trained using data 1 104A, teacher model 2 110B can be trained using data 2 104B, teacher model 3 110C can be trained using data 3 104C, and teacher model n 110D can be trained using data n 104D.

Data flow 100 can include obtaining output from the plurality of teacher models 110. The output can be obtained by aggregate teacher model 115. By way of example, aggregate teacher model 115 can obtain output for teacher models 110 and generate a data structure comprising the distribution of the output data. In some implementations, the data structure can be a histogram. In some instances, the histogram can represent a frequency of an output result obtained from the plurality of teacher models 110.

By way of example, an output result obtained from a respective teacher model of the plurality of teacher models 110 can be indicative of a class of a respective input.

Data flow 150 can include obtaining data x 105 from private data 103. Data x 105 can be a subset of private data 103. In some implementations, data x 105 can be the entirety of private data 103. Private data 103 and private data 102 can be disjoint sets of data. Private data 103 and private data 102 can be distinct sets of private data. Data x 105 can be modified to generate modified data 125 (e.g., as described in FIG. 2).

Aggregate teacher model 115 can be used to generate labels for modified data 130. Labels for modified data 130 and modified data 125 can be used to train student model 135. Student model 135 can be a publicly available model. Queries 140 can be run on student model 135 an infinite number of times without sacrificing additional differential privacy budget spent in the initial training of the aggregate teacher model 115. Thus, the student model can be made publicly available without risk of sacrificing further privacy related to the original private dataset(s).

As described herein, the present disclosure provides for recovering decision boundaries of the respective teacher models at a fair resolution. As the teacher ensemble gives a correct label to a data point, it will be useful for the publicly available student model even if the data point is not “real” data, it can be useful for training the publicly available student model. The modified dataset (e.g., perturbed dataset) can be extremely noisy (and thus more differentially private) and still be useful for training the publicly available student model.

This provides for technical benefits. For example, unlike a model that generates completely new modified data, this data has a similarity of distribution to the original private dataset. Thus, different models are being used for generation of the modified dataset and categorizing the dataset (e.g., processing the modified dataset by the trained teacher model to generate labels for the modified data and training the student model on the labeled modified data).

As described in FIG. 1A and FIG. 1B, data x (e.g., data x 120 or data x 105) can be used to generate modified data 125. The generation of modified data 125 is discussed with regard to FIG. 2.

FIG. 2 depicts an example block diagram for generation of modified data (e.g., modified data 125). Data flow 200 can include obtaining private data 205. By modified data generator 210. Modified data generator 210 can perform one or more processes to alter private data 205. The one or more processes can include data perturbation methods (e.g., data modification methods). In some implementations perturbation methods include adding noise to private data 205. For example, noise can include a differentially private covariance matrix, Bayesian noise, Laplacian noise, Exponential Mechanism noise, Gaussian noise, or any other noise adding mechanism.

In some implementations, private data 205 can include an entire private dataset. In some implementations, private data 205 can include a subset of a larger private dataset that is reserved (e.g., not used in training teacher models 110 of FIG. 1A and FIG. 1B) for generating labels and training the publicly available student model without reusing data subsets used in the initial teacher model training. In some implementations, private data 205 can include a private set of data separate from the private data used to train teacher models (e.g., as depicted by private data 102 and private data 103 in FIG. 1B). In some implementations, private data 205 can be disjoint from training data subsets (e.g., data subsets 104). In some implementations, private data 205 can overlap with one or more training data subsets (e.g., data subsets 104).

Data flow 200 can include obtaining modified data 215 as output from modified data generator 210. Modified data 215 can be used to train a publicly accessible machine learned model (e.g., via knowledge distillation, supervised learning).

The utilization of PATE with modified data allows for the decision boundaries to be drawn on the private data (e.g., original data) so that more advanced or well-fitted models can be used to learn original correlations between data (e.g., input data, private data) and labels (e.g., output from the teacher models). The modified data (e.g., modified data 215) can then transfer the original decision boundaries to the student model (e.g., as depicted in FIG. 1A and FIG. 1B).

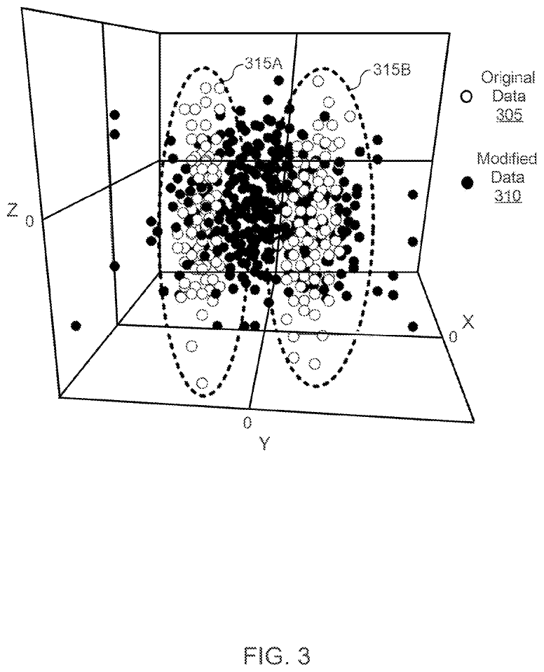

FIG. 3 depicts an example graphical representation 300 of original data 305 and modified data 310. As discussed herein, original data 305 can correspond to private data (e.g. private data 102, private data 205) that is not publicly accessible. In some implementations private data can be data associated with one or more user device identifiers.

Modified data 310 can be generated by a computing system to estimate modified data distribution from a differentially private covariance matrix. As depicted in graphical representation 300, the original data 305 can include two distinct groupings of data (e.g., group 315A and group 315B). Modified data 310 can be modified extensively to produce modified data 310. In some implementations, modified data 310 can have a similar distribution to original data 305 (e.g., generally similarly centered).

One example means for generating modified data 310 is described herein. For example, modified data can be generated from a multivariate gaussian by assuming a mean-centered distribution where the maximum L2 of any user is upper-bounded by 1 and taking a differentially private estimation of the covariance matrix. The differentially private covariance matrix can result in a barbaric view of the original dataset. However, the methods described herein can produce meaningful results while using this exceptionally low-resolution data.

While the present disclosure provides this example for generating modified data 310, it is contemplated that alternative modified data generation methods can be used. For example, some modified data generation schemes can produce decision boundaries that can be close to the decision boundaries of the private data (e.g., original data).

Starting with original private data to generate the modified data opposed to completely generating the modified data provides for additional technical benefits. By way of example, there can be issues with using modified data and labels that rely on a data generation scheme to learn correlations in the input data well enough to discern labels. If the modified data generator cannot learn the correct correlations between data and labels, the publicly available student model will be fed incorrect labels and whatever is used to model the data will not be helpful due to the data generator poisoning the task. This is compared to the benefit of the present disclosure which modifies private data which allows for a separation between the model which generates the modified data and the teacher models that generate the labels used for training the publicly available student model. By separating these tasks between models, the poisoning of the task of learning the decision boundary can be avoided or reduced.

Thus, the present disclosure that utilizes PATE with modified data generation (e.g., from a private dataset) allows the decision boundaries to be drawn on the private data (e.g., original data) so that more advanced or well-fitted models can be used to learn the original correlations between the data and labels. The modified data can then be utilized to transfer the original decision boundaries to the student as described herein.

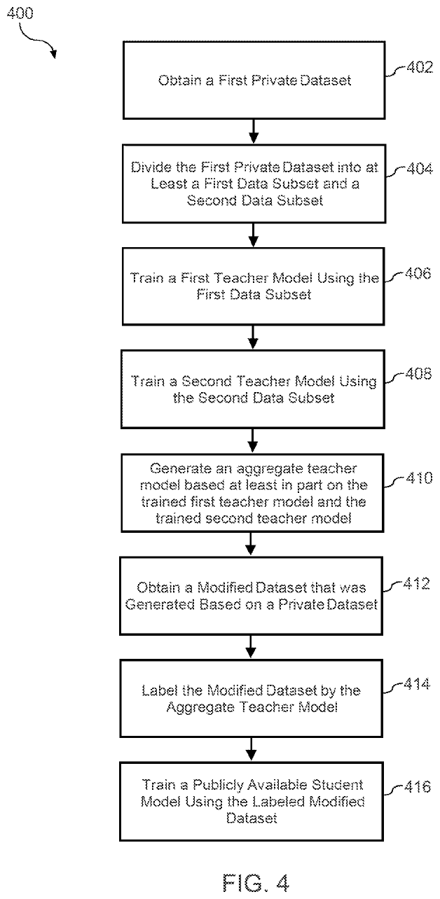

FIG. 4 depicts a flow chart diagram of an example method 400 for utilizing fully private ensembles using modified knowledge transfer. Although FIG. 4 depicts steps performed in a particular order for purposes of illustration and discussion, the methods of the present disclosure are not limited to the particularly illustrated order or arrangement. The various steps of method 400 can be omitted, rearranged, combined, or adapted in various ways without deviating from the scope of the present disclosure.

At (402), method 400 includes obtaining a private dataset. For instance, a computing system can obtain a private dataset. As described herein method 400 can include obtaining a dataset D and performing a noisy aggregation function A. As described herein, a private dataset can be a dataset not available for public inspection.

At (404), method 400 includes dividing the private dataset into at least a first data subset and the second data subset. For instance, a computing system can divide the private dataset into at least a first data subset and the second data subset. As described herein the first data subset and the second data subset can be disjoint subsets of the private dataset. In some implementations the first data subset and the second data subset can be overlapping subsets. By way of example, the first data subset and the second data subset can contain at least one common datum.

In some implementations, the method can include splitting dataset D into chunks C₁, C₂, . . . , Cₙ. There can be any number of chunks (e.g., data subsets). By way of example, there can be tens, hundreds, thousands (e.g., one thousand, ten thousand, fifty thousand, five hundred thousand), or the like number of chunks (e.g., data subsets). In some instances, the chunks of data can be disjoint datasets with no overlapping data. In some instances, the chunks of data can overlap and contain at least one common datum.

At (406), method 400 includes training a first teacher model using the first data subset. For instance, a computing system can train a first teacher model using the first data subset

At (408), method 400 includes training a second teacher model using the second data subset. For instance, a computing system can train a second teacher model using the second data subset.

By way of example, the method can include training a teacher model Tᵢ on each Ci to create ensemble E={T₁, T₂, . . . , Tₙ}. There can be any number of teacher models. By way of example, there can be tens, hundreds, thousands (e.g., one thousand, ten thousand, fifty thousand, five hundred thousand), and the like number of teacher models. The number of teacher models can correspond to the number of data subsets (also known as chunks). Thus, each teacher model can be trained on a respective data subset (e.g., chunk).

At (410), method 400 includes generating an aggregate teacher model based at least in part on the trained first teacher model and the trained second teacher model. For instance, a computing system can generate an aggregate teacher model based at least in part on the trained first teacher model and the trained second teacher model. As described herein the first and second teacher models can include at least one of regression models, classification models, naive Bayesian models, neural networks, decision trees, random first models, or support vector machines. By way of example, the method can include training a teacher model Tᵢ on each Ci to create ensemble E={T₁, T₂, . . . , Tₙ}.

At (412), method 400 can include obtaining a modified dataset that was generated based on a private dataset. In some examples, obtaining the modified dataset comprises generating a modified dataset based on the private dataset. For instance, a computing system can generate a modified dataset based on the private dataset. As described herein, generating the modified dataset can include obtaining a private data subset. The private data subset can be at least one of a third data subset of the private dataset or a second private dataset. As described herein, the method can include modifying (e.g., perturbing) dataset D in a differentially private way to generate D¹. Generating D¹ can incur a ε₁ privacy budget cost.

Generating the modified dataset can include performing a method to modify the private data subset. In some implementations, performing the method to modify the private data subset can include adding noise to the data subset. For example, noise can be Bayesian noise, Laplace noise, or noise added through any noise addition methods. By way of example, noise addition methods can include random noise addition, rotation perturbation, projection perturbation, k-anonymization model, private covariance matrix, Bayesian noise, Laplacian noise, Exponential Mechanism noise, Gaussian noise, or any other noise adding mechanism (e.g., as described with respect to FIG. 2). Generating the modified dataset can include obtaining output comprising the modified dataset in response to performing the operation to modify the private data subset.

Additionally, or alternatively, generating the modified dataset can include performing a differentially private generation algorithm of the private dataset. Generating the modified dataset can include obtaining, from the private generation algorithm, output comprising the modified dataset. The modified dataset can include an unlabeled modified dataset.

At (414), method 400 includes labeling the modified dataset by the aggregate teacher model. For instance, a computing system can label the modified dataset by the aggregate teacher model. In other words, this step involves passing the modified dataset as input to the trained aggregate teacher model, and receiving as output from the modified teacher model the labeled modified dataset. As described herein, the method can include gathering labels from teachers: L=A(E(D¹)). Gathering labels from teachers can incur a 22 privacy budget cost. By way of example, method 400 can include providing the modified data as input to the teacher ensemble (e.g., to each trained teacher model). The teacher ensemble can generate labels for the modified data (e.g., by each trained teacher model generating an output comprising a “vote” for the proper classification of the input modified data). The labeled modified data can be used to train the publicly available student model.

In some implementations, generated dataset D¹ (e.g., modified dataset) can include class-overlap data which can bound a maximum attainable accuracy. However, when datapoints exist that the teacher classifiers cannot agree on, the privacy budget to release these data points can be very high. To avoid releasing these data points, the method can avoid releasing vote counts if an agreement between the teacher models is low. Thus, the privacy budget can be preserved for alternative allocations.

At (416), method 400 includes training a publicly available student model using the labeled modified dataset. For instance, a computing system can train a publicly available student model using the labeled modified dataset. As described herein the publicly available student model can be a non-differentially private machine learning algorithm. As described herein the student model can include at least one of regression models, classification models, naive Bayesian models, neural networks, decision trees, random forest models, or support vector machines.

As described herein, the method can include training a student S on D¹ with labels L. The total privacy budget can be represented as follows: ε_{T}=ε₁+ε₂. The present disclosure provides for a guaranteed privacy budget cost on dataset D of ε_{T}=ε₁+ε₂. While the methods described herein can provide for the same dataset D for training the teacher models as the student model, the methods can include training the teachers and student on different datasets. This would result in a spend of ε₁ on the dataset for the teacher models and ε₂ on the dataset used to train the student model.

Thus, this method provides for a technical solution of providing for a set amount of privacy spend for training a publicly available student model without use of publicly available training data.

In some implementations, method 400 can include determining that there is not a publicly available training dataset. Method 400 can include, in response to determining that there is not a publicly available training dataset, generating the modified dataset, labeling the modified dataset, and training the publicly available student model using the labeled modified dataset.

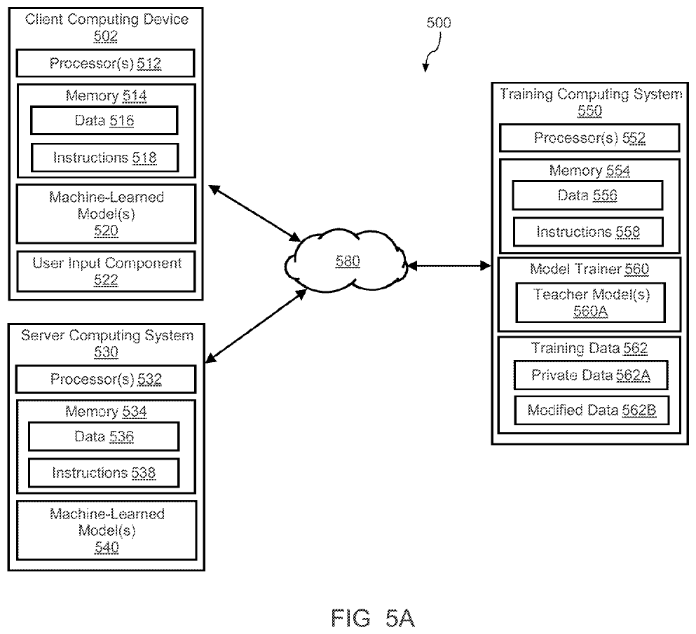

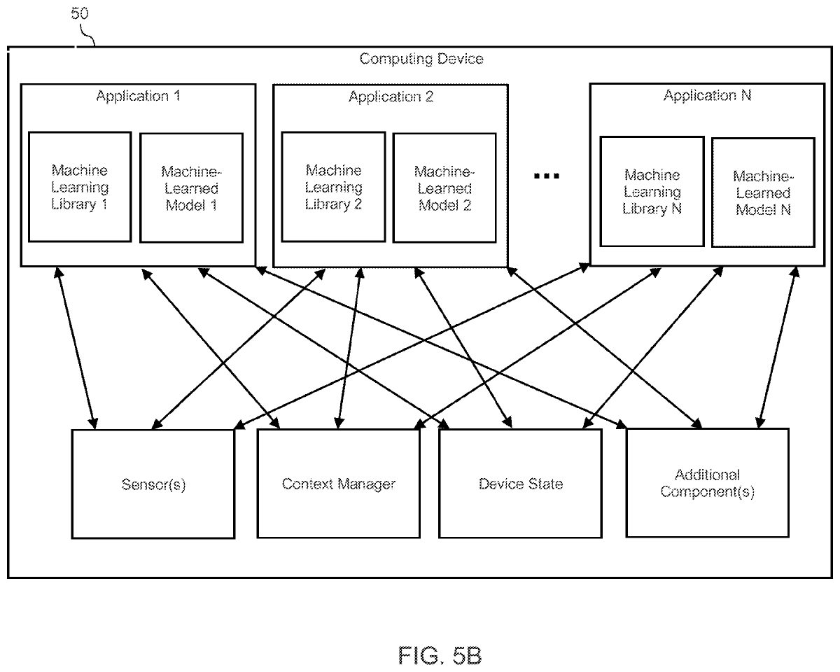

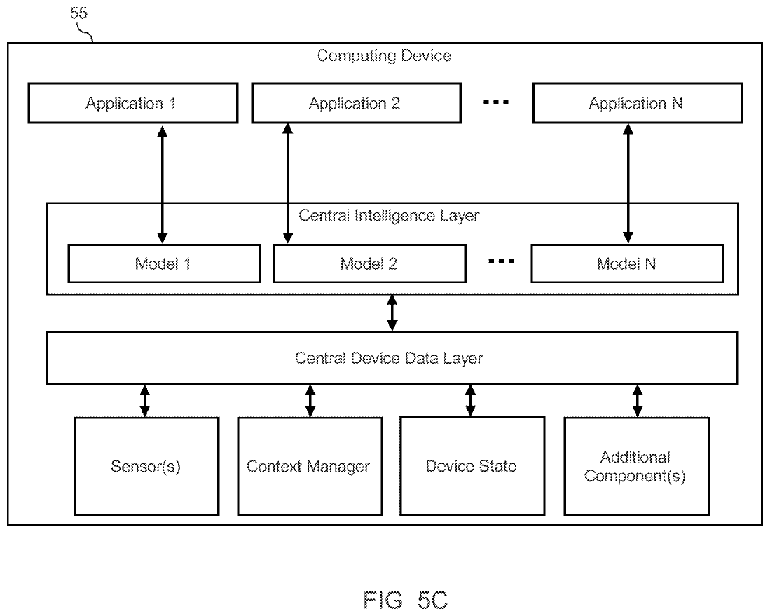

FIG. 5A depicts a block diagram of an example computing system 500 that provides for fully private ensembles using modified knowledge transfer. This allows for use and training of ensembles of machine learned models without access to public data according to example embodiments of the present disclosure. The computing system 500 includes a client computing system 502, a server computing system 530, and a training computing system 550 that are communicatively coupled over a network 580.

The client computing system 502 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The client computing system 502 includes one or more processors 512 and a memory 514. The one or more processors 512 can be any suitable processing device (e.g., a processor core, a microprocessor, an ASIC, an FPGA, a controller, a microcontroller, and the like) and can be one processor or a plurality of processors that are operatively connected. The memory 514 can include one or more computer-readable storage media (that are optionally non-transitory), such as RAM, ROM, EEPROM, EPROM, flash memory devices, magnetic disks, and the like, and combinations thereof. The memory 514 can store data 516 and instructions 518 which are executed by the processor 512 to cause the client computing system 502 to perform operations.

In some implementations, the client computing system 502 can store or include one or more student models 520. For example, the student models 520 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example student models 520 are discussed with reference to FIGS. 1A-1B, 2, and 3.

In some implementations, the one or more student models 520 can be received from the server computing system 530 over network 580, stored in the user computing device memory 514, and then used or otherwise implemented by the one or more processors 512. In some implementations, the client computing system 502 can implement multiple parallel instances of a single student model 520 (e.g., to perform parallel instances across multiple instances of the student model).

The PATE model paired with the use of generated (e.g., modified) data from a private dataset can provide advantages for implementations where public datasets are unavailable. Multiple CPU cores can be used to train the teacher models in parallel. Thus, training time for this method can provide for significant gains over a base model at a cost of using more cores for training the base model.

Additionally, or alternatively, one or more student models 540 can be included in or otherwise stored and implemented by the server computing system 530 that communicates with the client computing system 502 according to a client-server relationship. For example, the student models 540 can be implemented by the server computing system 530 as a portion of a web service (e.g., a healthcare service, an advertisement service). Thus, one or more student models 520 can be stored and implemented at the client computing system 502 or one or more student models 540 can be stored and implemented at the server computing system 530.

The client computing system 502 can also include one or more user input components 522 that receives user input. For example, the user input component 522 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 530 includes one or more processors 532 and a memory 534. The one or more processors 532 can be any suitable processing device (e.g., a processor core, a microprocessor, an ASIC, an FPGA, a controller, a microcontroller, and the like) and can be one processor or a plurality of processors that are operatively connected. The memory 534 can include one or more computer-readable storage media (that are optionally non-transitory), such as RAM, ROM, EEPROM, EPROM, flash memory devices, magnetic disks, and the like, and combinations thereof. The memory 534 can store data 536 and instructions 538 which are executed by the processor 532 to cause the server computing system 530 to perform operations.

In some implementations, the server computing system 530 includes or is otherwise implemented by one or more server computing devices. In instances in which the server computing system 530 includes plural server computing devices, such server computing devices can operate according to sequential computing architectures, parallel computing architectures, or some combination thereof.

As described above, the server computing system 530 can store or otherwise include one or more student models 540. For example, the student models 540 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example student models 540 are discussed with reference to FIGS. 1A-1B, 2, and 3.

The client computing system 502 or the server computing system 530 can train the student models 520 or 540 via interaction with the training computing system 550 that is communicatively coupled over the network 580. The training computing system 550 can be separate from the server computing system 530 or can be a portion of the server computing system 530.

The training computing system 550 includes one or more processors 552 and a memory 554. The one or more processors 552 can be any suitable processing device (e.g., a processor core, a microprocessor, an ASIC, an FPGA, a controller, a microcontroller, and the like) and can be one processor or a plurality of processors that are operatively connected. The memory 554 can include one or more computer-readable storage media (that are optionally non-transitory), such as RAM, ROM, EEPROM, EPROM, flash memory devices, magnetic disks, and the like, and combinations thereof. The memory 554 can store data 556 and instructions 558 which are executed by the processor 552 to cause the training computing system 550 to perform operations. In some implementations, the training computing system 550 includes or is otherwise implemented by one or more server computing devices.

The training computing system 550 can include a model trainer 560 that trains the machine-learned models 520 or 540 stored at the client computing system 502 or the server computing system 530 using various training or learning techniques, such as, for example, backwards propagation of errors. For example, a loss function can be back propagated through the model(s) to update one or more parameters of the model(s) (e.g., based on a gradient of the loss function). Various loss functions can be used such as mean squared error, likelihood loss, cross entropy loss, hinge loss, or various other loss functions. Gradient descent techniques can be used to iteratively update the parameters over a number of training iterations.

In some implementations, performing backwards propagation of errors can include performing truncated backpropagation through time. The model trainer 560 can perform a number of generalization techniques (e.g., weight decays, dropouts, and the like) to improve the generalization capability of the models being trained.

In particular, the model trainer 560 can train the student models 520 or 540 based on a set of training dataset 562. The training dataset 562 can include, for example, private data 562A and modified data 562B. Private data 562A can be used to train the teacher models 520 or 540. Modified data 562B can be used to train student models 520 or 540. For example, teacher models 540 can be stored on a private server. In some implementations, student models 520 and 540 can be stored on a private server or accessible by a user device (e.g., associated with a client computing system).

Private data 562A can be data that should not be shared outside an organization. Private data 562A can be a single dataset or multiple datasets. Private data 562A can include a plurality of data subsets. The plurality of data subsets can be disjoint subsets. The plurality of data subsets can include some overlapping values.

Modified data 562B can be generated (e.g., by client computing system 502 or server computing system 530). Modified data 562B can be generated from private data 562A. For example, modified data 562B can be generated by taking a subset of private data 562A and adding noise to the data. Modified data 562B can be generated by performing a differential privacy algorithm on the subset of private data 562A. In some implementations, training can include processing modified data 562B by teacher models 560A to generate labels for modified data 562B. The labeled modified data 562B can be used to train student models 520 or 540 (e.g., through knowledge distillation).

In some implementations, if the user has provided consent, the training examples can be provided by the client computing system 502. Thus, in such implementations, the student model 520 provided to the client computing system 502 can be trained by the training computing system 550 on user-specific data received from the client computing system 502. In some instances, this process can be referred to as personalizing the model.

The model trainer 560 includes computer logic utilized to provide desired functionality. The model trainer 560 can be implemented in hardware, firmware, or software controlling a general purpose processor. For example, in some implementations, the model trainer 560 includes program files stored on a storage device, loaded into a memory and executed by one or more processors. In other implementations, the model trainer 560 includes one or more sets of computer-executable instructions that are stored in a tangible computer-readable storage medium such as RAM, hard disk, or optical or magnetic media.

The network 580 can be any type of communications network, such as a local area network (e.g., intranet), wide area network (e.g., Internet), or some combination thereof and can include any number of wired or wireless links. In general, communication over the network 580 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The machine-learned models described in this specification may be used in a variety of tasks, applications, or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, and the like). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, and the like). As another example, the machine-learned model(s) can process the image data to generate an encoded image data output (e.g., an encoded or compressed representation of the image data, and the like). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, and the like). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded or compressed representation of the speech data, and the like). As another example, the machine-learned model(s) can process the speech data to generate an upscaled speech output (e.g., speech data that is higher quality than the input speech data, and the like). As another example, the machine-learned model(s) can process the speech data to generate a textual representation output (e.g., a textual representation of the input speech data, and the like). As another example, the machine-learned model(s) can process the speech data to generate a prediction output.

In some implementations, the input to the machine-learned model(s) of the present disclosure can be latent encoding data (e.g., a latent space representation of an input, and the like). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable or efficient transmission or storage (or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 5A illustrates one example computing system that can be used to implement the present disclosure. Other computing systems can be used as well. For example, in some implementations, the client computing system 502 can include the model trainer 560 and the training dataset 562. Training dataset 562 can include private data 562A or modified data 562B. In such implementations, the student models 520 can be both trained and used locally at the client computing system 502. In some of such implementations, the client computing system 502 can implement the model trainer 560 to personalize the student models 520 based on data.

FIG. 5B depicts a block diagram of an example computing device 50 that performs according to example embodiments of the present disclosure. The computing device 50 can be a user computing device or a server computing device.

The computing device 50 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, and the like

As illustrated in FIG. 5B, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 5C depicts a block diagram of an example computing device 55 that performs according to example embodiments of the present disclosure. The computing device 55 can be a user computing device or a server computing device.

The computing device 55 includes a number of applications (e.g., applications 1 through N). Each application is in communication with a central intelligence layer. Example applications include a text messaging application, an email application, a dictation application, a virtual keyboard application, a browser application, and the like In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 55.

The central intelligence layer can communicate with a central device data layer. The central device data layer can be a centralized repository of data for the computing device 55. As illustrated in FIG. 5C, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

The depicted or described steps are merely illustrative and can be omitted, combined, or performed in an order other than that depicted or described; the numbering of depicted steps is merely for ease of reference and does not imply any particular ordering is necessary or preferred.

The functions or steps described herein can be embodied in computer-usable data or computer-executable instructions, executed by one or more computers or other devices to perform one or more functions described herein. Generally, such data or instructions include routines, programs, objects, components, data structures, or the like that perform particular tasks or implement particular data types when executed by one or more processors in a computer or other data-processing device. The computer-executable instructions can be stored on a computer-readable medium such as a hard disk, optical disk, removable storage media, solid-state memory, read-only memory (ROM), random-access memory (RAM), or the like. As will be appreciated, the functionality of such instructions can be combined or distributed as desired. In addition, the functionality can be embodied in whole or in part in firmware or hardware equivalents, such as integrated circuits, application-specific integrated circuits (ASICs), field-programmable gate arrays (FPGAs), or the like. Particular data structures can be used to implement one or more aspects of the disclosure more effectively, and such data structures are contemplated to be within the scope of computer-executable instructions or computer-usable data described herein.

Although not required, one of ordinary skill in the art will appreciate that various aspects described herein can be embodied as a method, system, apparatus, or one or more computer-readable media storing computer-executable instructions. Accordingly, aspects can take the form of an entirely hardware embodiment, an entirely software embodiment, an entirely firmware embodiment, or an embodiment combining software, hardware, or firmware aspects in any combination.

As described herein, the various methods and acts can be operative across one or more computing devices or networks. The functionality can be distributed in any manner or can be located in a single computing device (e.g., server, client computer, user device, or the like).

Aspects of the disclosure have been described in terms of illustrative embodiments thereof. Numerous other embodiments, modifications, or variations within the scope and spirit of the appended claims can occur to persons of ordinary skill in the art from a review of this disclosure. For example, one or ordinary skill in the art can appreciate that the steps depicted or described can be performed in other than the recited order or that one or more illustrated steps can be optional or combined. Any and all features in the following claims can be combined or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, or equivalents to such embodiments. Accordingly, the subject disclosure does not preclude inclusion of such modifications, variations, or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, or equivalents.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Terms are described herein using lists of example elements joined by conjunctions such as “and,” “or,” “but,” and the like It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

1. A system, comprising:
one or more processors; and
one or more computer-readable media storing instructions that are executable to cause the one or more processors to perform operations, the operations comprising:
obtaining a first private dataset;
dividing the first private dataset into at least a first data subset and a second data subset;
training a first teacher model using the first data subset;
training a second teacher model using the second data subset;
generating an aggregate teacher model based at least in part on the trained first teacher model and the trained second teacher model;
obtaining a modified dataset that was generated based on a private dataset;
labeling the modified dataset by the aggregate teacher model; and
training a publicly available student model using the labeled modified dataset.

2. The system of claim 1, wherein the publicly available student model is a non-differentially private machine learning algorithm.

3. The system of claim 1, wherein obtaining the modified dataset comprises:
obtaining a private data subset, wherein the private data subset is at least one of a third data subset of the private dataset or wherein the private data subset is a second private dataset;
performing a method to modify the private data subset; and
obtaining output comprising the modified dataset in response to performing the method to modify the private data subset.

4. The system of claim 3, wherein performing the method to modify the private data subset comprises adding noise to the private data subset.

5. The system of claim 1, wherein obtaining the modified dataset comprises:
performing a differentially private generation algorithm on the private dataset; and
obtaining, from the differentially private generation algorithm, output comprising the modified dataset, wherein the modified dataset comprises an unlabeled modified dataset.

6. The system of claim 1, wherein the at least first teacher model and second teacher model comprise at least one of regression models, classification models, naive Bayesian models, neural networks, decision trees, random first models, or support vector machines.

7. The system of claim 1, wherein the publicly available student model comprises at least one of regression models, classification models, naive Bayesian models, neural networks, decision trees, random forest models, or support vector machines.

8. The system of claim 1, wherein the first data subset and the second data subset are disjoint subsets of the private dataset.

9. The system of claim 1, the operations comprising:
determining that there is not a publicly available training dataset; and
in response to determining that there is not a publicly available training dataset, generating the modified dataset, labeling the modified dataset, and training the publicly available student model using the labeled modified dataset.

10. The system of claim 1, wherein obtaining the modified dataset comprises:
dividing the private dataset into at least the first data subset, the second data subset, and a third data subset, wherein the first data subset, the second data subset, and the third data subset are disjoint subsets of the private dataset;
performing a differentially private generation algorithm on the third data subset; and
obtaining, from the differentially private generation algorithm, output comprising the modified dataset, wherein the modified dataset comprises an unlabeled modified dataset.

11. A computer-implemented method, comprising:
obtaining a first private dataset;
dividing the first private dataset into at least a first data subset and a second data subset;
training a first teacher model using the first data subset;
training a second teacher model using the second data subset;
generating an aggregate teacher model based at least in part on the trained first teacher model and the trained second teacher model;
obtaining a modified dataset that was generated based on a private dataset;
labeling the modified dataset by the aggregate teacher model; and
training a publicly available student model using the labeled modified dataset.

12. The method of claim 11, wherein the publicly available student model is a non-differentially private machine learning algorithm.

13. The method of claim 11, wherein obtaining the modified dataset comprises:
performing a differentially private generation algorithm on the private dataset; and
obtaining, from the differentially private generation algorithm, output comprising the modified dataset, wherein the modified dataset comprises an unlabeled modified dataset.

14. The method of claim 13, wherein generating the modified dataset comprises adding noise to the private dataset.

15. (canceled)

16. (canceled)

17. (canceled)

18. The method of claim 11, comprising:
determining that there is not a publicly available training dataset; and
in response to determining that there is not a publicly available training dataset, generating the modified dataset, labeling the modified dataset, and training the publicly available student model using the labeled modified dataset.

19. The method of claim 11, wherein generating the modified dataset comprises:
dividing the private dataset into at least the first data subset, the second data subset, and a third data subset, wherein the first data subset, the second data subset, and the third data subset are disjoint subsets of the private dataset;
performing a differentially private generation algorithm on the third data subset; and
obtaining, from the differentially private generation algorithm, output comprising the modified dataset, wherein the modified dataset comprises an unlabeled modified dataset.

20. The method of claim 11, wherein the private dataset contains medical records of a plurality of individuals.

21. The method of claim 11, wherein the private dataset contains advertisement data associated with a plurality of advertisers.

22. The method of claim 11, comprising:
obtaining a second private dataset;
inputting the second private dataset into the trained student model; and
obtaining output from the trained student model indicative of a prediction associated with the second private dataset.

23. A non-transitory computer readable medium embodied in a computer-readable storage device and comprising instructions that, when executed by a processor, cause the processor to perform operations, the operations comprising:
obtaining a first private dataset;
dividing the first private dataset into at least a first data subset and a second data subset;
training a first teacher model using the first data subset;
training a second teacher model using the second data subset;
generating an aggregate teacher model based at least in part on the trained first teacher model and the trained second teacher model;
obtaining a modified dataset that was generated based on a private dataset;
labeling the modified dataset by the aggregate teacher model; and
training a publicly available student model using the labeled modified dataset.
